(19) United States
(12) Patent Application Publication
(10) Pub. No.: US 2016/0107538 A1
(43) Pub. Date: Apr. 21, 2016

(54) LIFT ASSIST SYSTEMS AND METHODS

(71) Applicant: Sameh Mesallum, Boston, MA (US)

(72) Inventor: Sameh Mesallum, Boston, MA (US)

(21) Appl. No.: 14/722,454

(22) Filed: May 27, 2015

Related U.S. Application Data
(60) Provisional application No. 62/005,206, filed on May 30, 2014.

(51) Int. Cl. B60L 13/03; B60L 13/06

(52) U.S. Cl. CPC B60L 13/035; B60L 13/06

(57) ABSTRACT

Provides are lift assist systems and methods that employ the angular momentum generated by drive bodies travelling along curvilinear guide tracks to provide a lifting force. The tracks and bodies can be positioned on heavy objects to provide lift reducing an energy requirement associated with moving such heavy objects. The system can use a plurality of connected curved guide portions positioned to maximize lift generated by the track. In various embodiments, one or more drive bodies are moveably connected to the guide track. The drive bodies are configured to accelerate along the guide track increasing the lift generated as the drive bodies traverse the guide track. In some embodiments, the guide track includes a plurality of magnetic sections that operate on magnetic sections of the drive bodies. In one embodiment, the polarity of the track sections can manipulated between positive, negative, and none to manage movement of the drive bodies.

### RELATED APPLICATIONS

This application priority under 35 U.S.C. §119(e) to U.S. Provisional Patent Application Ser. No. 62/005,206 entitled “LIFT ASSIST SYSTEMS AND METHODS,” filed May 30, 2014, which application is incorporated herein by reference in their entirety.

### BACKGROUND

Centrifugal force is the apparent force that draws a rotating body away from the center of rotation. “Centrifugal force” is caused by the inertia of the body moving in an arc or circle. In Newtonian mechanics, the term centrifugal force is used to refer to the inertial force (also called a “fictitious” force) observed in a non-inertial reference frame. The concept of centrifugal force is applied in rotating devices such as centrifuges, centrifugal pumps, centrifugal governors, centrifugal clutches, etc., as well as in centrifugal railways, planetary orbits, banked curves, etc.

### SUMMARY

Stated broadly various aspects and embodiments are directed to lift assist systems and methods that employ the angular momentum generated by drive bodies travelling along curvilinear guide tracks to provide lifting force resulting from the inertia of the drive bodies. The guide tracks and drive bodies can be positioned on heavy objects to provide lift, reducing an overall energy requirement associated with moving such heavy objects.

According to one embodiment, the system uses a plurality of connected curved guide portions positioned to maximize lift generated by the track. In various embodiments, one or more drive bodies are moveably connected to the guide track. The drive bodies are configured to accelerate along the guide track increasing the lift generated as the drive bodies traverse the guide track. In some embodiments, the guide track includes a plurality of magnetic sections that operate on respective magnetic sections of the drive bodies. In further embodiments, either of the guide track and drive body can include fixed and/or electromagnets that can be configured to force the drive bodies along the guide track. For example, the drive bodies can be constructed of fixed magnets that provide at least two polarity sections of the drive body. The polarity associated with the guide track can be manipulated, for example, by application of electricity to cause the drive bodies to move along the guide track.

According to one embodiment, the guide track can be connected to a control unit configured to manipulate the polarity of the magnetic sections of the guide track. The polarity of the magnetic sections can be changed with increasing frequency to force the drive body along the guide track at increasing velocity. According to some embodiments, the corresponding lift generated increases as the velocity of the drive body increases.

According to one aspect, a lift assist system is provided. The lift assist system comprises a magnetic car coupled to a magnetic rail, the magnetic rail, wherein the magnetic rail defines a cyclic track and includes a plurality of magnetic portions, at least one curved portion of the rail, a control unit configured to manipulate a magnetic field associated with at least the magnetic car or at least the magnetic rail, wherein the magnetic car is driven along the magnetic rail responsive to the manipulation of the magnetic field by the control unit, and wherein the at least one curved portion is constructed of an arc, such that in response to the magnetic car travelling along the arc, a lifting force is generated by the lift assist system.

According to one embodiment, the magnetic rail includes a plurality of curved portions each having a respective arc such that in response to the magnetic car travelling along the respective arc, a lifting force is generated by the lift assist system. According to one embodiment, the system further comprises a plurality of magnetic cars, wherein operation of the plurality of magnetic cars is configured to create the lifting force generated by the lift assist system.

According to one embodiment, the control unit is further configured to sequentially manipulate a magnetic field produced by the plurality of magnetic portions of the rail. According to one embodiment, the control unit is further configured to synchronize the movements of a plurality of magnetic cars along the plurality of curved portions of the magnetic rail. According to one embodiment, synchronizing the movements includes synchronizing a first magnetic car and a second magnetic car such that as the first magnetic car travels along a first section of a first curved portion the second car travels along a second section of a second curved portion and the angular momentum of the first and second car combine to generate an upwardly directed force.

According to one embodiment, the control unit is further configured to pair at least two magnetic cars, and control operations of at least a plurality of the at least two paired magnetic cars. According to one embodiment, the control unit is further configured to maintain a spacing and speed for the at least two paired magnetic cars such that the angular momentum of the at least two paired magnetic cars combine to generate a force directed substantially upward. According to one embodiment, the control unit is further configured to determine a spacing required between a first and second magnetic car such that the average force generated from their respective angular momentum is directed substantially upward and minimizes any other directional force. According to one embodiment, the control unit is further configured to determine an average upward force generated by a plurality of pairs of magnetic cars and manipulate a spacing and speed of the magnetic cars to minimize any forces generated that are not upwardly directed.

According to one aspect a method for generating a lifting force is provided. The method comprises moveably mating a plurality of magnetic cars to a magnetic rail that defines a cyclic track and includes at least a plurality of magnetic portions and a plurality of curved portions, varying, by a control unit, a polarity of selective ones of the plurality of magnetic portions of the magnetic rail to induce motion by a first one of the plurality of magnetic car along the cyclic track, varying, the control unit, a polarity of selective other ones of the plurality of magnetic portions of the magnetic rail to induce motion by a second one of the plurality of magnetic cars along the cyclic track, and sequencing, by the control unit, both acts of varying to maintain a spacing between the first and second magnetic cars, wherein the spacing is calculated to maximize a lifting force resulting from the angular momentum of the first and second magnetic cars.

According to one embodiment, sequencing includes manipulating a magnetic field produced by the plurality of magnetic portions of the rail. According to one embodiment, sequencing includes synchronizing movement of each one of a plurality of magnetic cars along the plurality of curved portions of the magnetic rail. According to one embodiment, the method further comprises pairing at least two magnetic cars, and controlling based on pairs of magnetic cars the operation the plurality of magnetic cars. According to one embodiment, the method further comprises maintaining a spacing and a speed for at least two paired magnetic cars such that the angular momentum of the at least two paired magnetic cars combine to generate a force directed substantially upward.

According to one embodiment, the method further comprises determining a spacing required between a first and second magnetic car such that the average force generated from their respective angular momentum is directed substantially upward. According to one embodiment, the act of determining the spacing required includes minimizing an average of laterally directed forces. According to one embodiment, the method further comprises determining an average upward force generated by the plurality magnetic cars, and adjusting a respective spacing and a respective speed of one or more of the magnetic cars to minimize any laterally directed forces.

Still other aspects, embodiments and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment. References to “an embodiment,” “an example,” “some embodiments,” “some examples,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. Where technical features in the figures, detailed description or any claim are followed by reference signs, the reference signs have been included for the sole purpose of increasing the intelligibility of the figures, detailed description, and claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. The figures are provided for the purposes of illustration and explanation and are not intended as a definition of the limits of the invention. In the figures:

FIG. 1 is a view of a rotation of a body travelling in a circular path, according to one embodiment;

FIG. 2 is a view of a rotation of a ball travelling a partial circular path, according to one embodiment;

FIG. 3 is a view of a rotation of a ball travelling a partial circular path, according to one embodiment;

FIG. 4 is a view of a rotation of two balls travelling a partial circular path, according to one embodiment;

FIG. 5 is a graphical representation of the force generated from the movement of a ball travelling the partial circular path, according to one embodiment;

FIG. 6 is a graphical representation of the force generated from the movement of two balls travelling the partial circular path, according to one embodiment;

FIG. 7 is directional graph of the force generated by pendular motion of a pair of drive bodies, according to one embodiment;

FIG. 8 is a view of a portion of a guide track and drive body, according to one embodiment;

FIG. 9 is a view of a curved portion of a guide track and drive body, according to one embodiment;

FIG. 10 is a view of two curved portion of a guide track and drive bodies, according to one embodiment;

FIG. 11 is directional graph of the force generated by motion of a body in a circle;

FIG. 12 is a view of a curved guide track and drive body generating unidirectional centrifugal force, according to one embodiment;

FIG. 13A is a view showing an example embodiment of a track;

FIG. 13B is a view of another embodiment of a magnetic track;

FIG. 14 is a view of another embodiment of a magnetic rail having a spiral configuration, according to one embodiment;

FIG. 15 is a view of another embodiment of a lift device, according to one embodiment;

FIG. 16 is a view of another example embodiment having a circular magnetic rail;

FIG. 17 is a view of another example embodiment including a curved magnetic rail portion;

FIG. 18 is a view of the movement paths of a magnetic car on section of rail, according to one embodiment;

FIG. 19 is a view of another embodiment having six magnetic cars;

FIG. 20 is a view of another embodiment having two circular sections with a reciprocal magnetic rail;

FIG. 21 is a view of another embodiment of a lift system containing an array of multiple magnetic curved sections;

FIG. 22 is a view of another embodiment having three lift devices;

FIG. 23 is a view of another embodiment having two lift devices operating;

FIG. 24 is a view of another embodiment of a lift assist system configured to generate magnetic upward force; and

FIG. 25 is a view of another embodiment including a fixed magnet car sliding on a magnetic rail.

### DETAILED DESCRIPTION

Stated broadly various aspects and embodiments are directed to lift assist systems and methods that employ the angular momentum generated by drive bodies travelling along curvilinear guide tracks to provide lifting force. The guide tracks and drive bodies can be positioned on heavy objects to provide lift reducing an overall energy requirement associated with moving such heavy objects.

According to one embodiment, the system uses a plurality of connected curved guide portions positioned to maximize lift generated by the track. In various embodiments, one or more drive bodies are moveably connected to the guide track. The drive bodies are configured to accelerate along the guide track increasing the lift generated as the drive bodies traverse the guide track. In some embodiments, the guide track includes a plurality of magnetic sections that operate on magnetic sections of the drive bodies. In further embodiments, either of the guide track and drive body can include fixed and/or electromagnets that can be configured to force the drive bodies along the guide track. For example, the drive bodies can be constructed of fixed magnets that provide at least two polarity sections of the drive body. The polarity associated with the guide track can be manipulated by application of electricity to cause the drive bodies to move along the guide track. In one embodiment, the polarity of the track sections can manipulated between positive, negative, and none to manage movement of the drive bodies.

In some embodiments, a lift system can include tilt sensors and/or accelerometers to evaluate positioning and/or orientation of the lift system. In one example, the system can include a control unit configured to manipulate the speed and/or spacing of the drive bodies (e.g., magnetic cars) to compensate for any tilt or lateral forces.

Examples of the methods, devices, and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may also be construed as inclusive so that any terms described using “or” may indicate any of a single, more than one, combinations of selective ones, and all of the described terms.

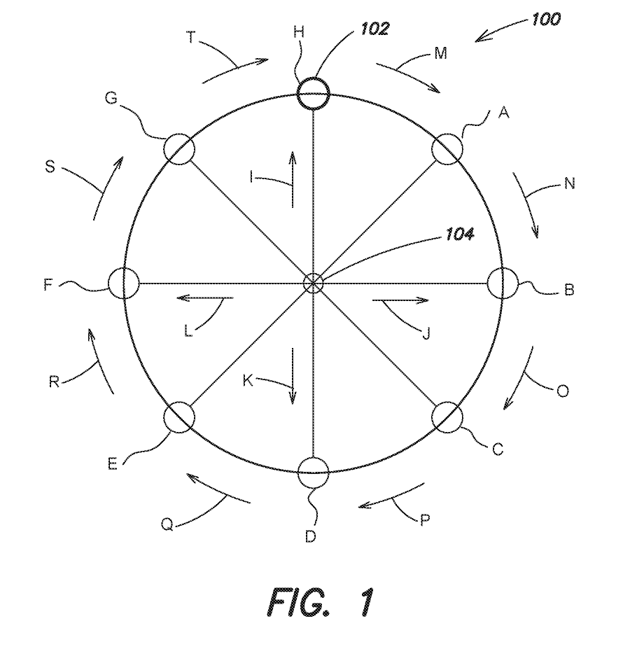

FIG. 1 is a view 100 of the circular rotation of a ball 102 (e.g., at positions A-H) with mass M around a center 104 at a speed S, which creates angled speed (e.g., shown by arrows M-T) and centrifugal force=M×S in all directions (e.g., at I-L). As shown, the circle of ball trajectory remains static due to force equalization.

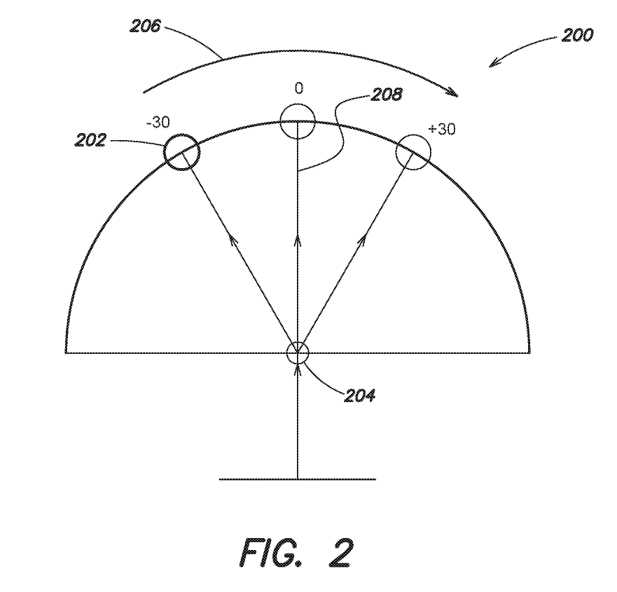

FIG. 2 is a view 200 of a rotation of a ball 202 with mass and speed S (e.g., along line 206) in a circle cut out section of 60°, from −30° to +30° around a centre 204, creates centrifugal force=M×S in the direction of the O degree axis (e.g., at 208) for a short period provided that no other opposing centrifugal force exists.

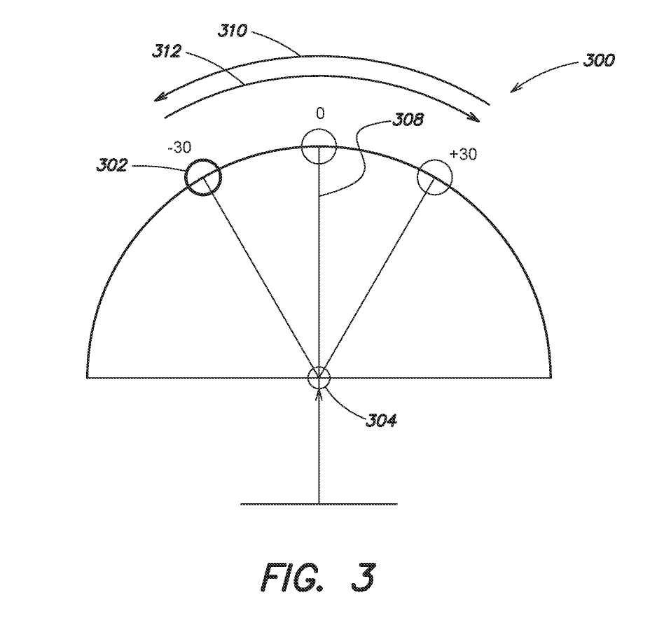

FIG. 3 is a view 300 of rotation of a ball 302 with mass M and speed S in a circle cut out section of 60° degrees around a center 304 (0°), which creates directional centrifugal force M×S in the direction of 0° axis (e.g., 308) for a short period. Repetition of such movement in a pendular fashion (e.g., shown by arrows 310 and 312) creates bursts of mechanical centrifugal force in the same direction.

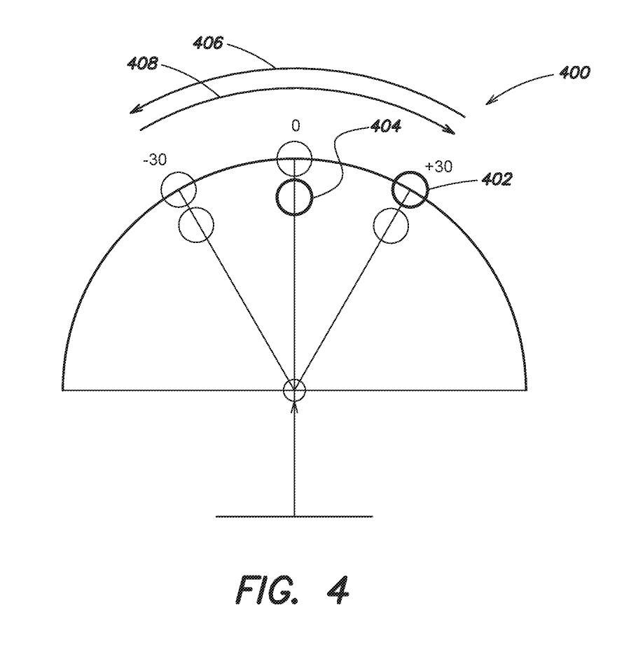

FIG. 4 is a view 400 of rotation of 2 balls (e.g., 402 and 404) on 2 pendulums, where each ball (402 and 404) travel along paths 406 and 408 in reverse directions so that if one pendulum is at 0° degrees the other is at 30°. If speed is at a maximum at 0°, the apparent centrifugal force is at a minimum where the pendulum is at either +30 or −30.

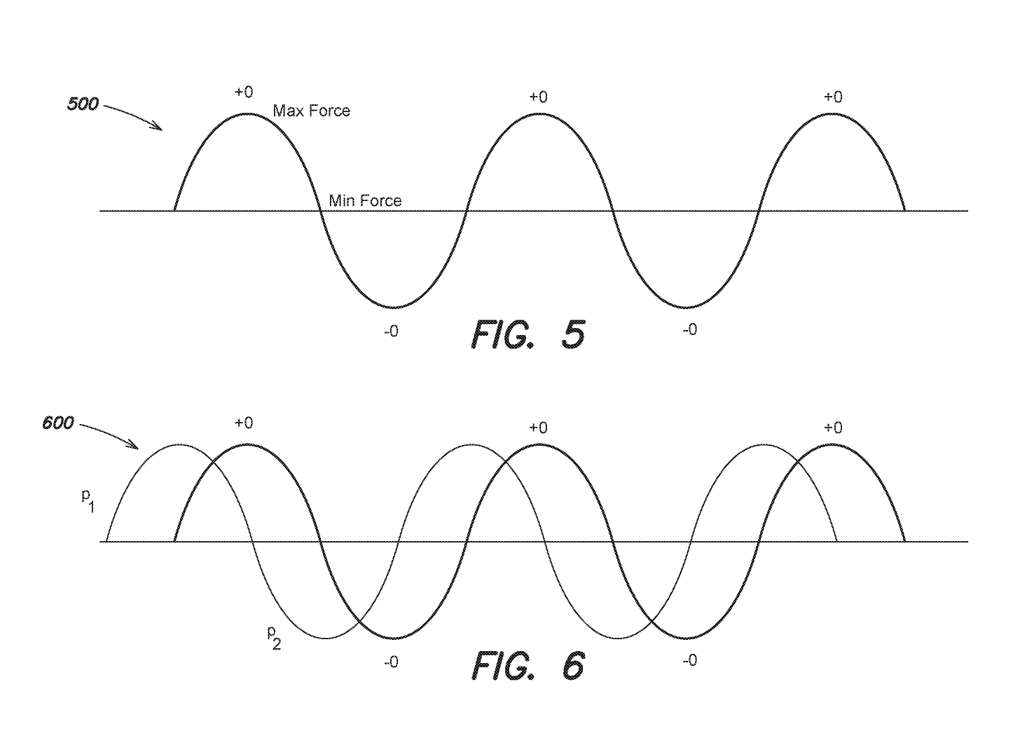

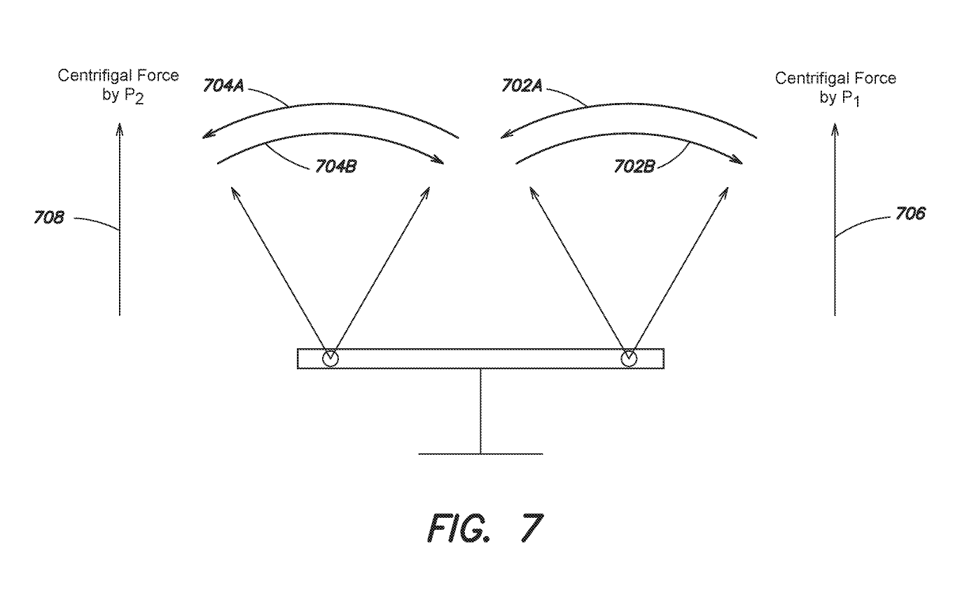

FIG. 5 is a graphical view 500 of centrifugal force generated by the pendular movement of one pendulum between +30° and −30° around an origin at 0°. The force is at a minimum when the ball is either at the +30 or −30 angles. FIG. 6 is a graphical view 600 of centrifugal force created by 2 pendulums (e.g., FIG. 4) moving in opposite directions around an origin at 0° axis in a range of +30 to −30 in a way that when the first pendulum is at min force (+30°) the other pendulum is at max force (+ or −0°) to offset the drop in force. In other embodiments, multiple pairs of drive bodies, and the motion of individual elements can be synchronized to achieve maximum lift between a first pair of individual elements. The motion of a second pair of drive bodies can be offset so that when the first pair of drive bodies reach a minimum lift, the second pair of drive bodies is at a maximal lift position. In other embodiments, the system can control any number of drive bodies individually.

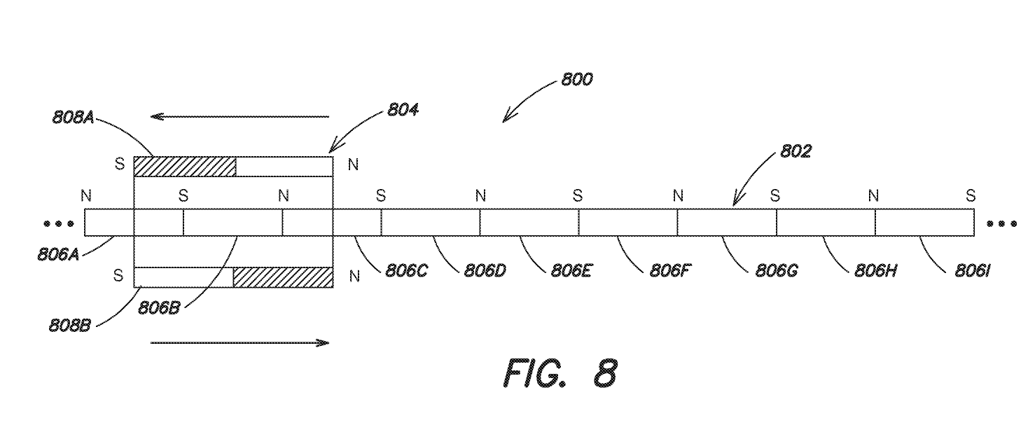

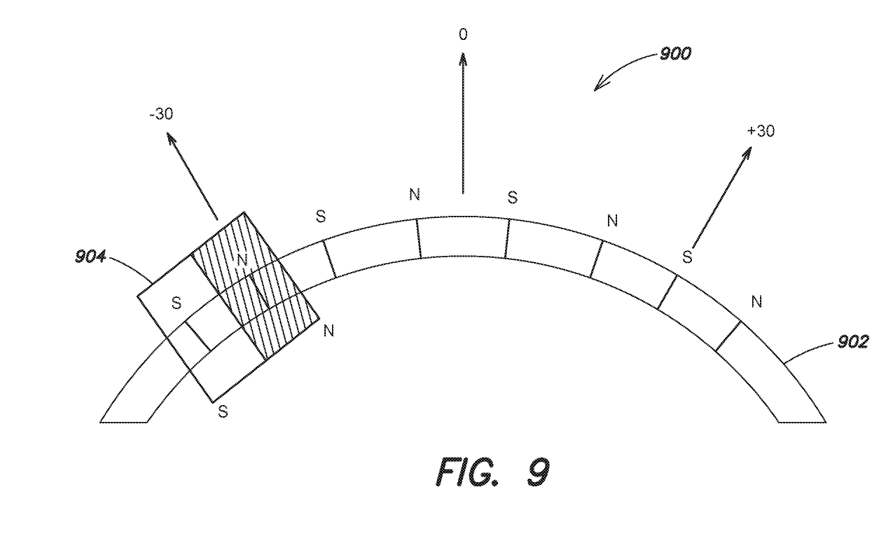

FIG. 7 is a view 700 of opposing pendulums moving back (e.g., traveling on paths 702A-702B and 704A-704B respectively) and forth at high frequency around the 0° axis (e.g., wherein the operation of the pendulums are staged to be perpendicular to ground) creates continuous centrifugal force both at the direction of 0° upward (e.g., shown by arrows 706 and 708) with minimum loss of force. FIG. 8 is a view 800 of magnetic rail 802 which can drive a car 804 along a path defined by the rail 802. In some embodiments, the rail is configured in a circle and by changing the polarity of the rail 802 magnets 806A-I or the car magnets 808A-B the car is driven around the circumference of the rail 802. According to some embodiments, the speed of the car can be increased by increasing the rate of polarity change of the magnets 806A-I and/or 808A-B. Further, the direction of movement of the car can also change by changing polarity of the magnets.

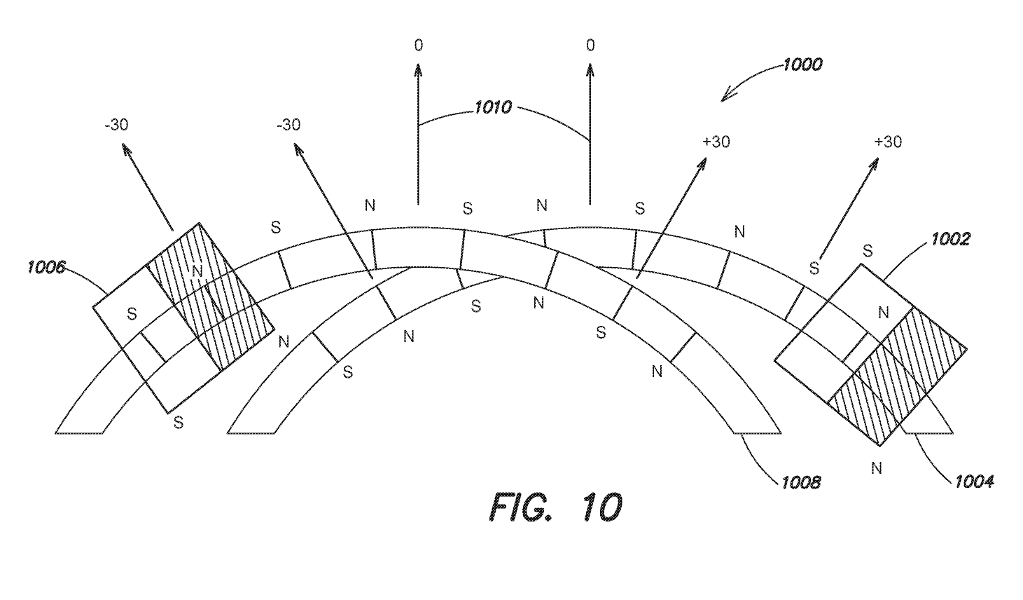

FIG. 9 is a view 900 of magnetic rail 902 in a curved configuration with a magnetic car 904 moveable around the circumference of the rail 902. The magnetic car 904 is configured to travel back and forth in a circular cut out portion shown (e.g., approximately 60° of movement between +30, −30 degrees of freedom. The angular speed of the car 904 creates centrifugal force in the direction of 0° and perpendicular to the movement along the rail. According to various embodiments, either one or both of the rail and magnetic car can include a plurality of electromagnetic elements configured to provide electromagnetic fields and respective polar magnetic fields (e.g., illustrated by N and S for North and South polar fields). The fields provided by the plurality of electromagnetic elements can be manipulated to control the movement of the car 904 along the rail 902 (e.g., speed, direction, etc.).

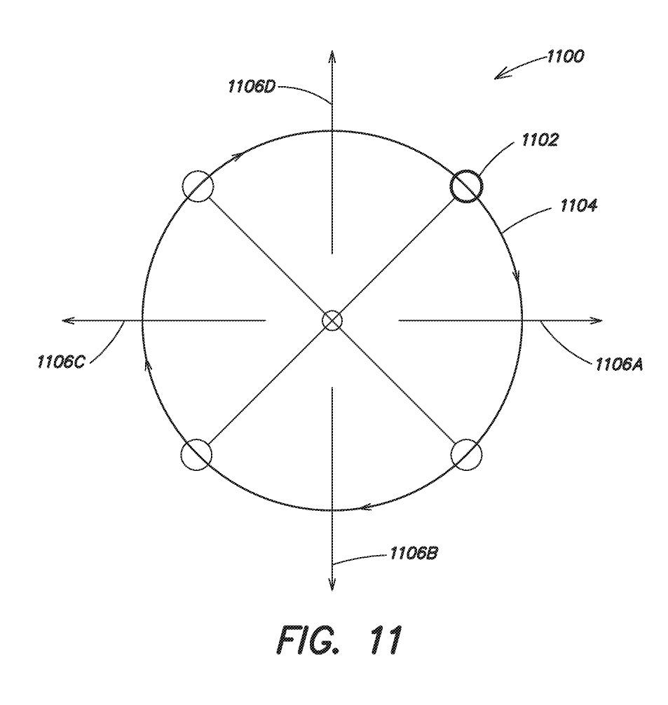

FIG. 10 is a view 1000 of the movement of two magnetic cars 1002 and 1006 on two rails 1004 and 1008 having the same curvature and dimensions (e.g., from −30 to +30). Assuming the cars 1002 and 1006 had the same mass and speed, their respective motion in opposite directions over the curved rails in (e.g., through 60° degree of freedom+30 to −30 around 0° axis) generates centrifugal force in the 0° axis direction. According to some embodiments, by synchronizing the movements of the two cars 1002 and 1006 so that they move along opposite portions of their respective curved rails (e.g., lower left portion of curved rail and lower right portions of curved rail) and in opposite direction the combined forces are directed along arrow 1010. According to various embodiments, a plurality of curved rail portions can be constructed or the same dimensions and oriented such that cars travelling along the rails generate a uniform force.

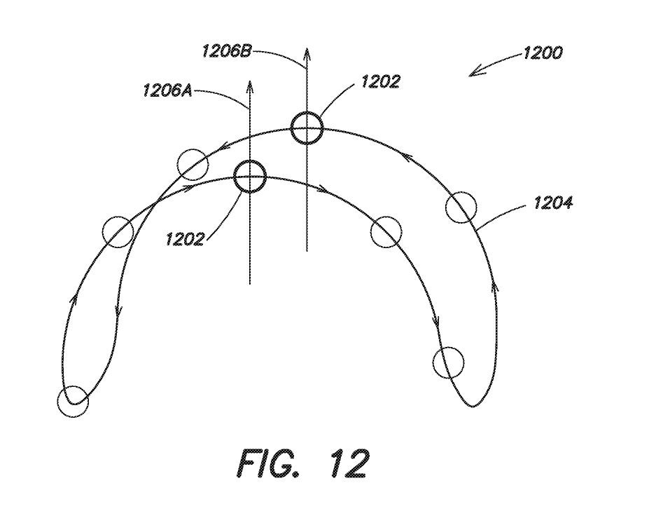

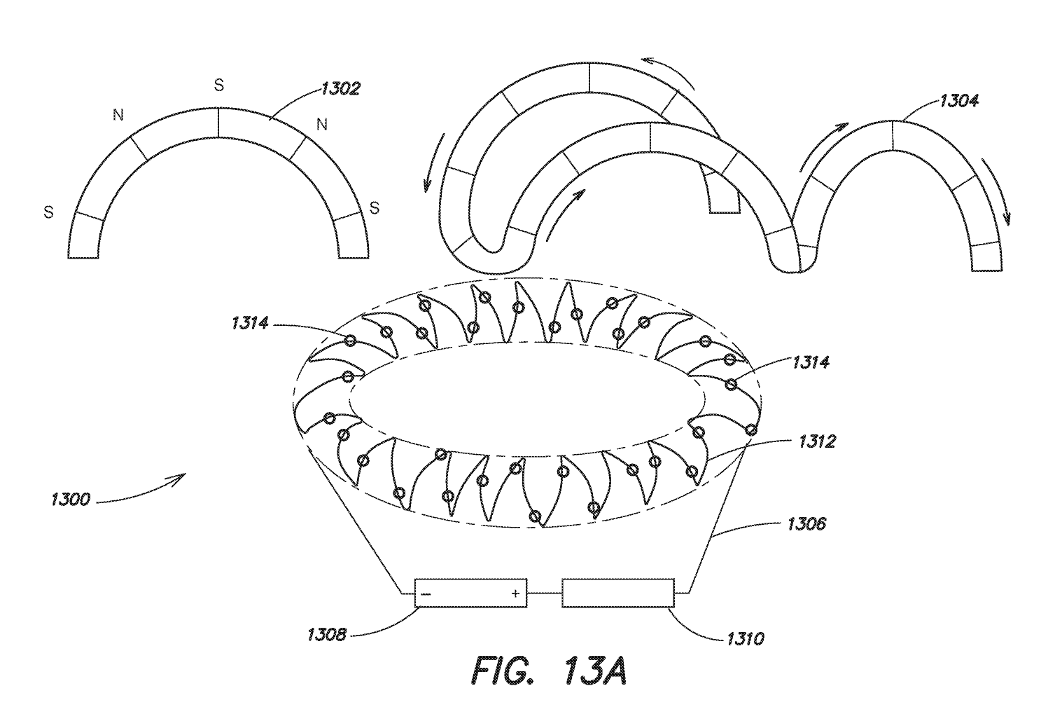

FIG. 11 is a view 1100 of a car 1102 travelling in a circle along path 1104 and the centrifugal force generated at 1106A-D, which is equal in all directions. FIG. 12 is a view 1200 of the lower half of the circle of FIG. 11, if it is flipped up. As ball 1202 travels along rail 1204 the continuous movement of the ball 1202 generates, in aggregate, unidirectional centrifugal force (e.g., 1206A-B). As shown in FIG. 12, the ball 1202 travels along the curvature of each section. The modification of the circle of FIG. 11 to obtain the configuration of FIG. 12, can be analogized to the curvature made by the outer circumference of a taco shell, where two opposed curved portions are joined together.

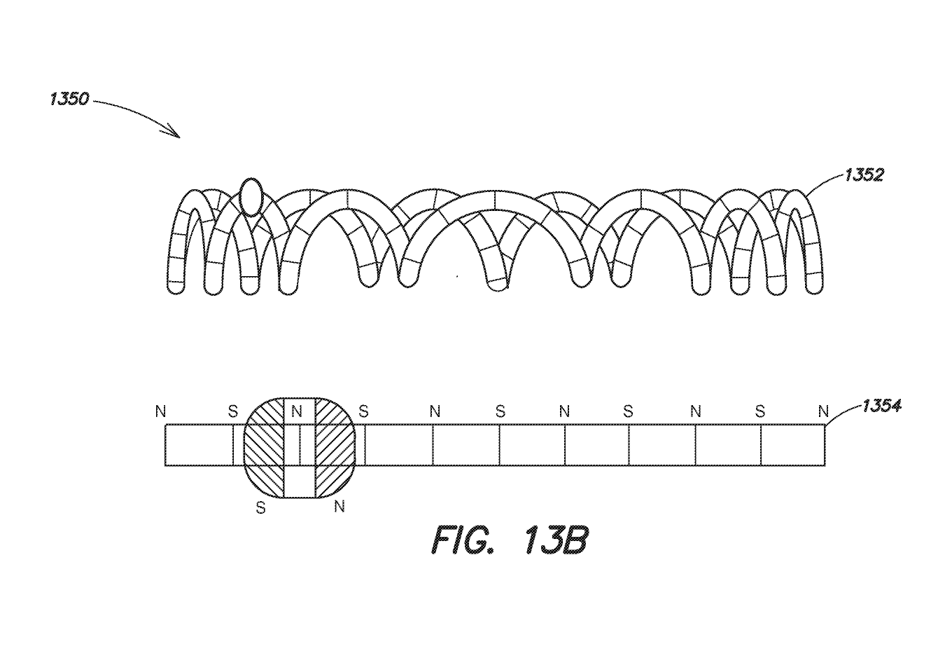

FIG. 13A is a view 1300 showing a first cut-out portion 1302 and a second cut-out portion 1304 of a curvature track 1312. 1302 and 1304 illustrate portions of the complete track 1312 which provides opposed curved portions along which a plurality of magnetic cars and/or bodies 1314 can travel in a complete loop. According to one embodiment, the track 1312 and/or respective ones of the plurality magnetic cars (e.g., 1314) include a plurality of electromagnetic portions. The electromagnetic portions can be controlled by a control unit 1310. The control unit can be configured to manipulate the magnetic fields generated at the plurality of electromagnetic portions. In one example, the control unit 1310 manipulates the polarity (e.g., N, S, off) of the electromagnetic portions to force the magnetic cars (e.g., 1314) along the track 1312. In some examples, the control unit can selectively apply power to the electromagnetic portion (e.g., from power supply 1308). The control unit 1310 can be configured to turn on or off the electromagnetic portions and/or reverse the polarity of the magnetic fields produced. According to one embodiment, the track 1312, magnetic cars (e.g., 1314) control unit 1310 and power supply 1308 can be fabricated together to form a lift assist device 1306. In one example, as the magnetic cars travel along the track 1312 the lift assist device creates and upwardly directed force. In further examples, as the velocity of the magnetic cars is increased the lifting force generated overcomes the weight of the lift assist device 1306, and the lift assist device can be used to affect a lifting force required to move heavy objects. FIG. 13B is a view 1350 of another embodiment of a magnetic track 1352 and an exploded view of a portion of the track at 1354.

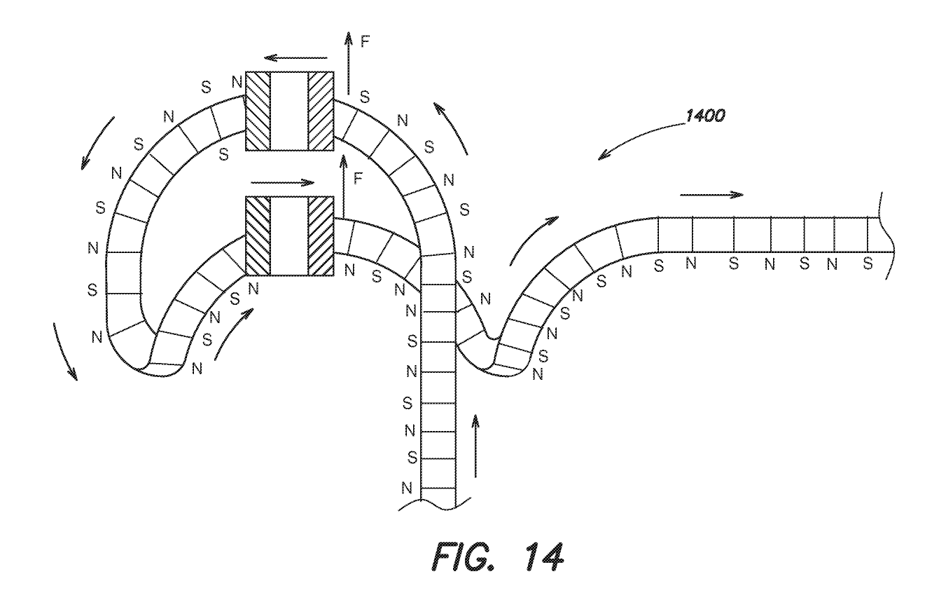

FIG. 14 is a view 1400 of another embodiment of a magnetic rail having a spiral configuration where alternating curves of the magnetic rail generate a centrifugal upward force as magnetic cars travel along the rail. According to one example, the centrifugal force generated is directly proportional to speed of the magnetic cars. In another example, the force generated can be calculated from the equation force (F)=mass of car times the speed of car on the curve. In some embodiments, the directionality of the force is calculated based on curvature of the rail and the position of the magnetic car on the rails. The calculation of force can be stored on the system and the system can manipulate the drive bodies to match velocity and position to already calculated values. The system can also be configured to access stored force calculations to manage positioning and speed of the magnetic cars travelling along the rail. According to some embodiments, responsive to determined force values (e.g., dynamically calculated or stored) the system is configured to manipulate positioning and/or speed of the magnetic cars.

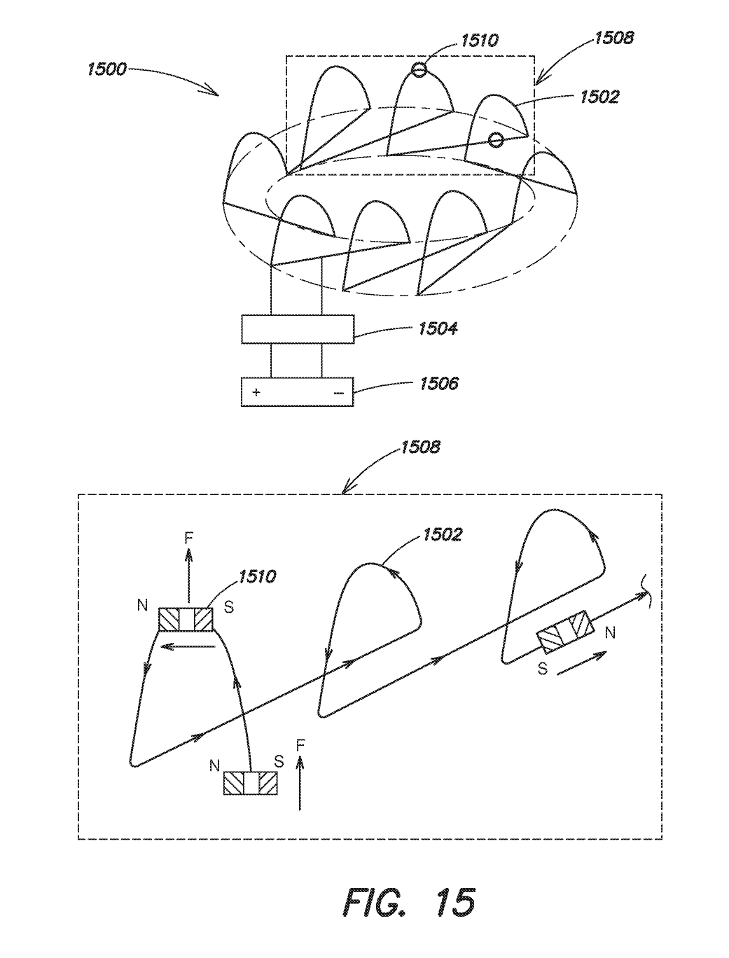

FIG. 15 is a view 1500 of another embodiment of a lift device and an exploded view of a cut-out portion 1508 of magnetic track 1502 of the lift device. According to one embodiment, the lift device includes magnetic cars (e.g., 1510). In some embodiments, the motion of the cars (e.g., 1510) can be controlled by a control unit 1504 that manages delivery of power (e.g., 1506 power supply) to electromagnetic portions of the track 1502. As shown, each car generates its own centrifugal force as it travels along the track 1502.

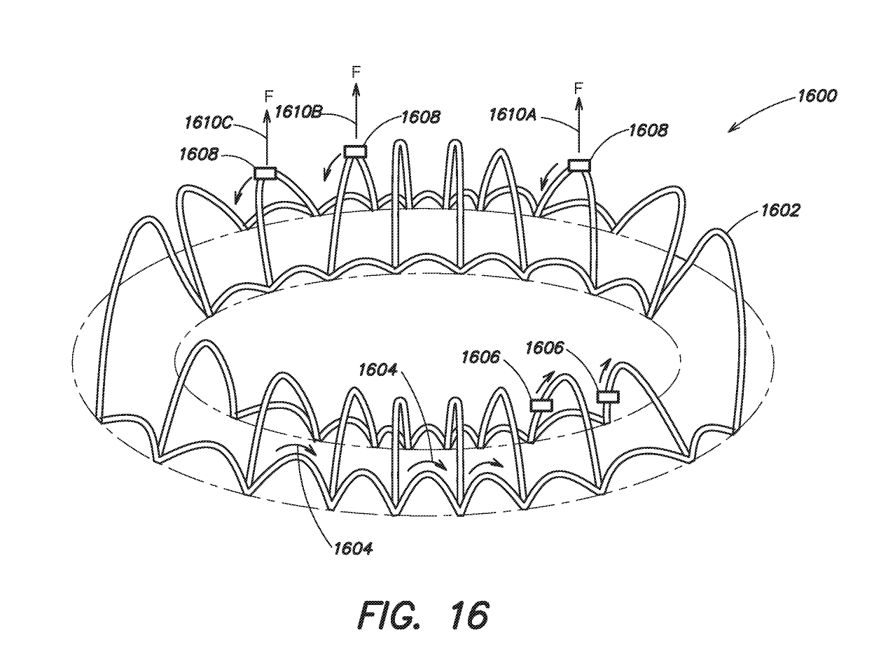

FIG. 16 is a view 1600 of another example embodiment having a circular magnetic rail 1602 carrying multiple magnetic cars (e.g., 1606 and 1608). As the cars move along the rail 1602 (e.g., along paths 1604), each car creates its own upward centrifugal force (e.g., 1610A-C).

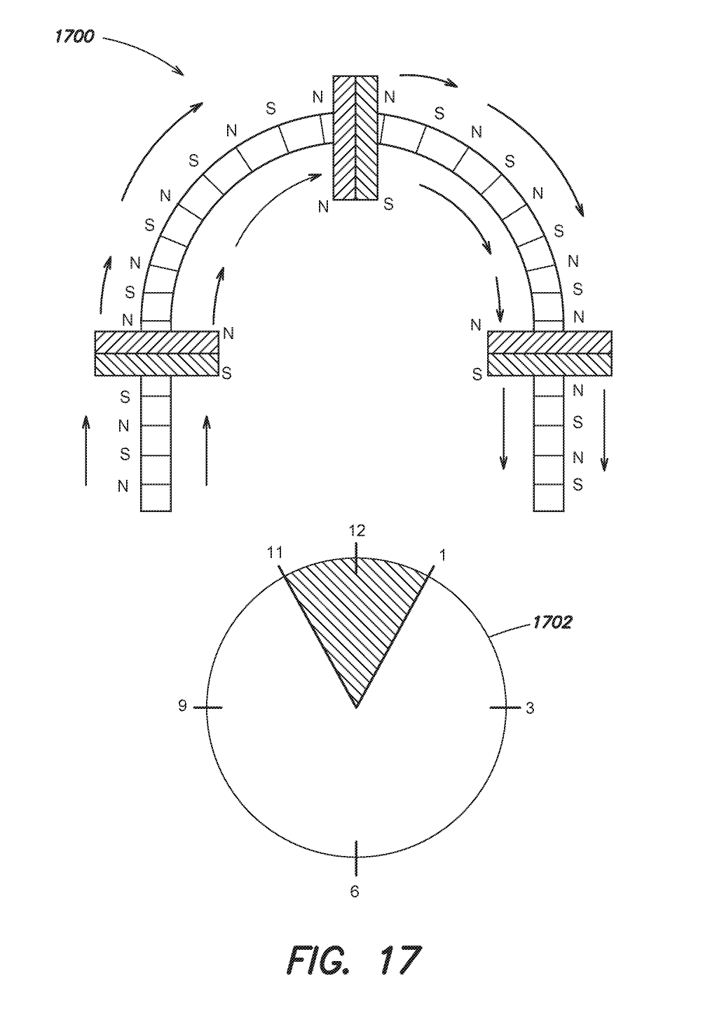

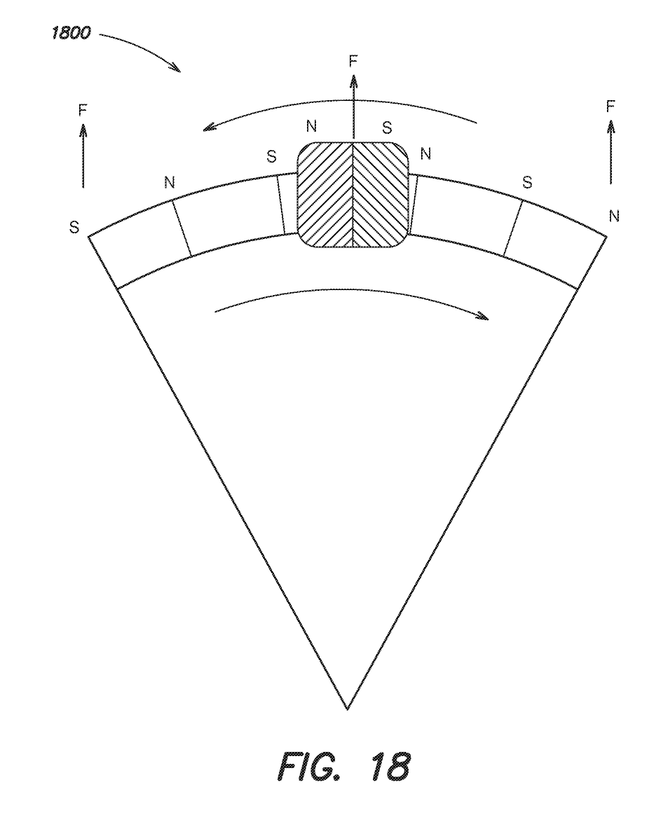

FIG. 17 is a view 1700 of another example embodiment including a curved magnetic rail portion, including a plurality of electromagnetic elements. Magnetic cars travel along the rail under the influence of manipulated magnetic fields. According to some embodiments, either of the rail or the cars can include fixed magnets and/or fixed magnetic fields of fixed polarity, which can be influenced by manipulation of electromagnetic fields proximate to the fixed magnetic fields. According to some examples, the curved portions is a cut out of a circle approximately between eleven and one o'clock (e.g., 1702). FIG. 18 is a view 1800 of the movement of a magnetic car on section of rail whose path is a cut out (11-1 o'clock) of a circle. Traversing the section back and forth at a high speed creates upward centrifugal force.

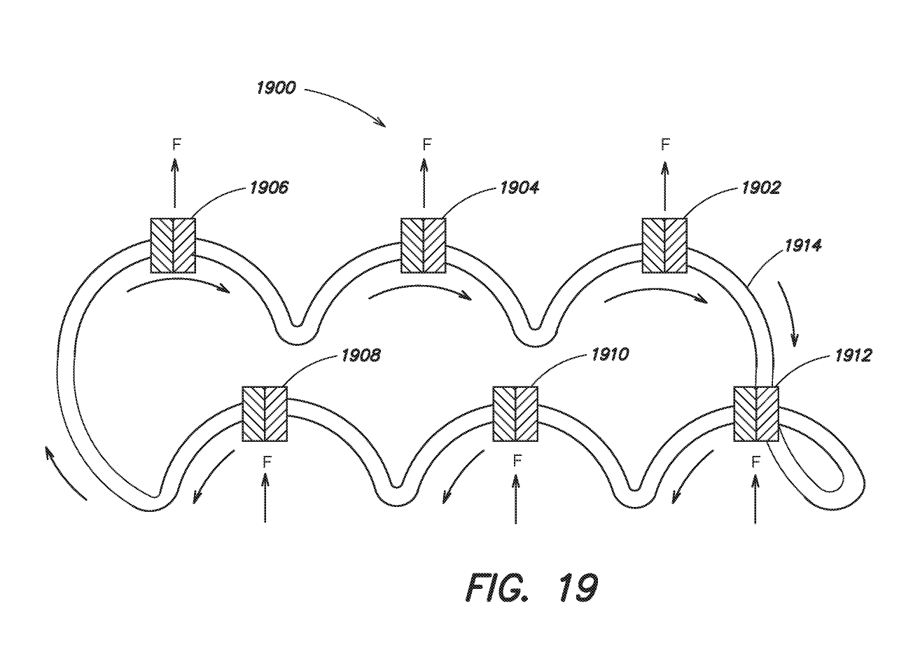

FIG. 19 is a view 1900 of another embodiment having six magnetic cars (e.g., 1902-1912) moving on a continuous magnetic rail 1914 having a spiral configuration. The cars (e.g., 1902-1912) are configured to travel at a high speed along the rail 1914, creating a lifting/upward centrifugal force as they move along the curved portions of the rail.

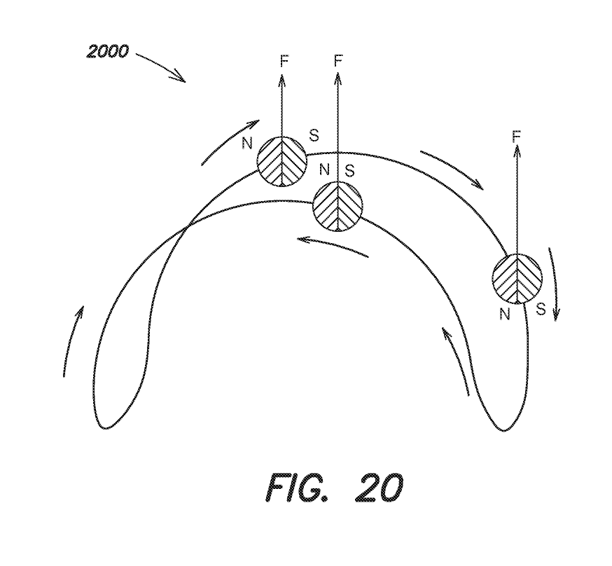

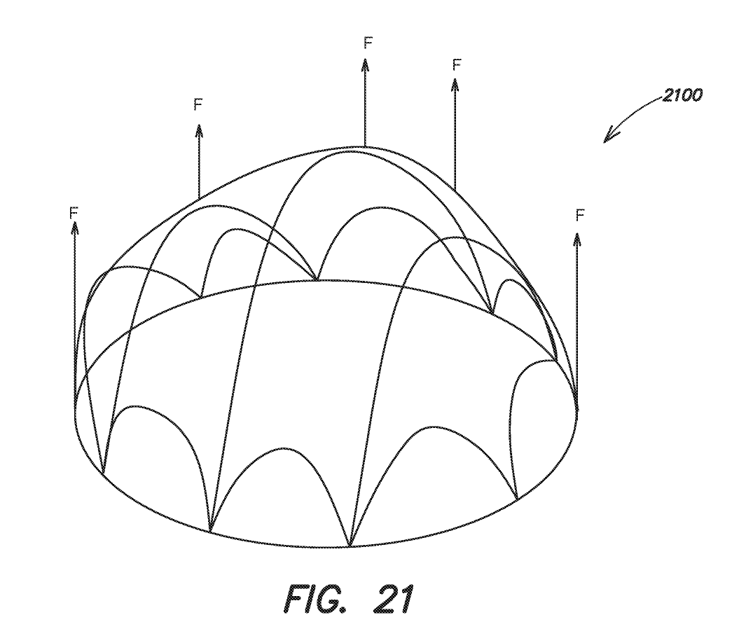

FIG. 20 is a view 2000 of another embodiment having two circular sections with a reciprocal magnetic rail. The cars and rail are configured for driving multiple magnetic cars at a continuous high speed on the two rails, and with each pass over any of the curved portions an upward/lifting centrifugal force is generated. FIG. 21 is a view 2100 of another embodiment of a lift system containing an array of multiple magnetic curved spiral sections driving multiple magnetic cars at high speed which creates enough upward/lifting force that can overcome the weight of the system and/or gravitational effects on the system.

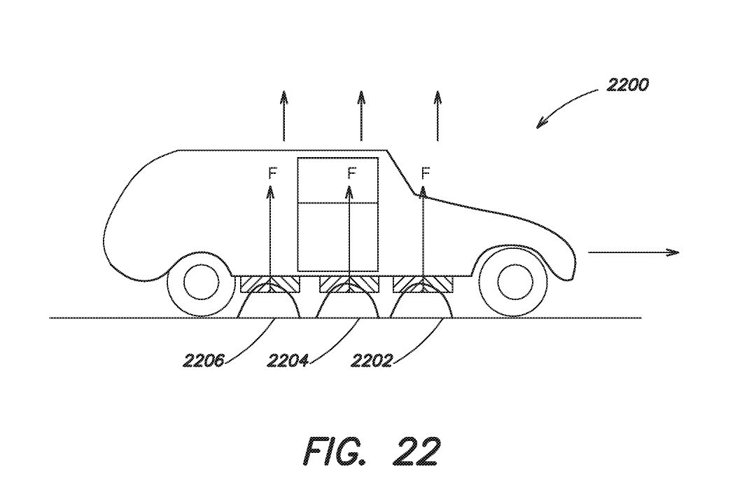

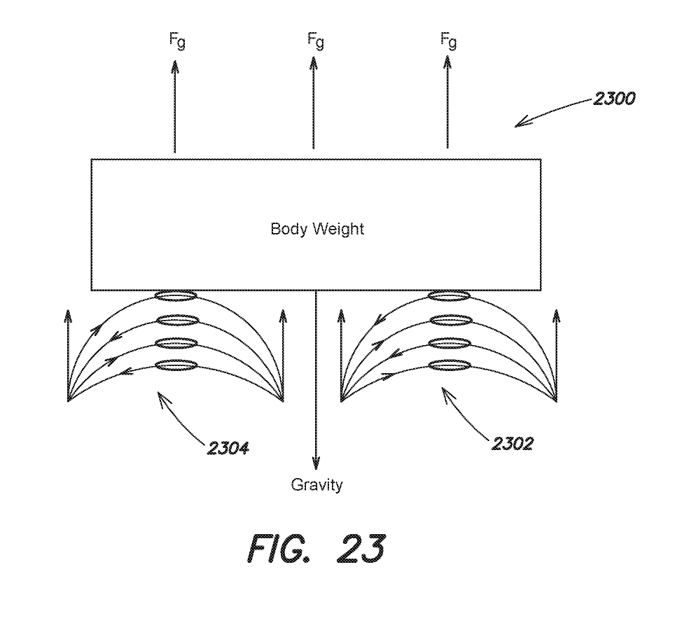

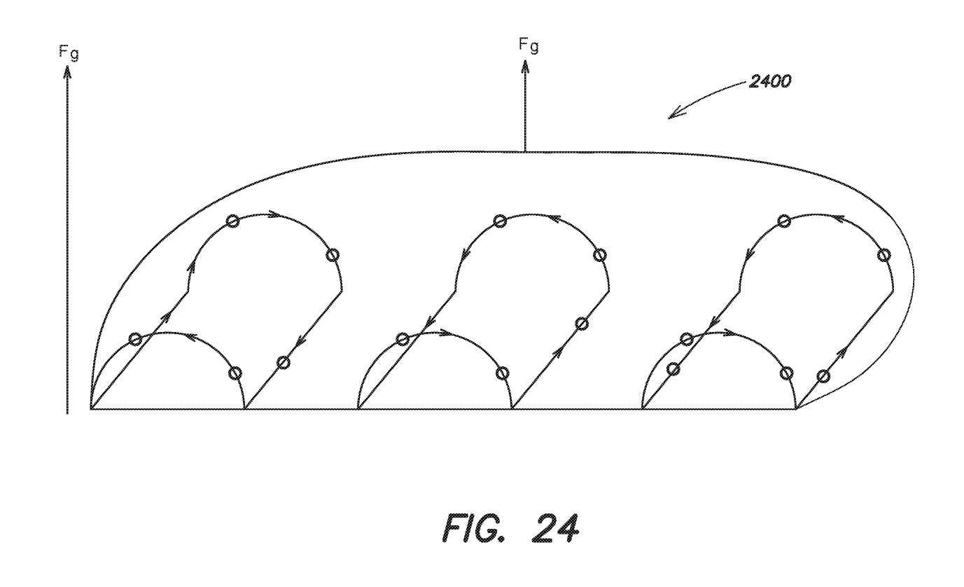

FIG. 22 is a view of another embodiment having three lift devices (e.g., 2202, 2204, and 2206) which can be attached to a heavy object to decrease the objects effective weight (e.g., reducing the weight of a car). FIG. 23 is a view 2300 of another embodiment having two lift devices operating to lift a body with a weight (w) against the operation of gravity (G) where F_{g}>G; Cₙ×C_{3>}G. F_{g}=number of magnetic cars (Cₙ)×speed of cars (Cₛ). FIG. 24 is a view 2400 of another embodiment of a lift assist system configured to generate magnetic upward centrifugal levitation, in order to reduce the effects of gravity by creating upward Force F_{g}.

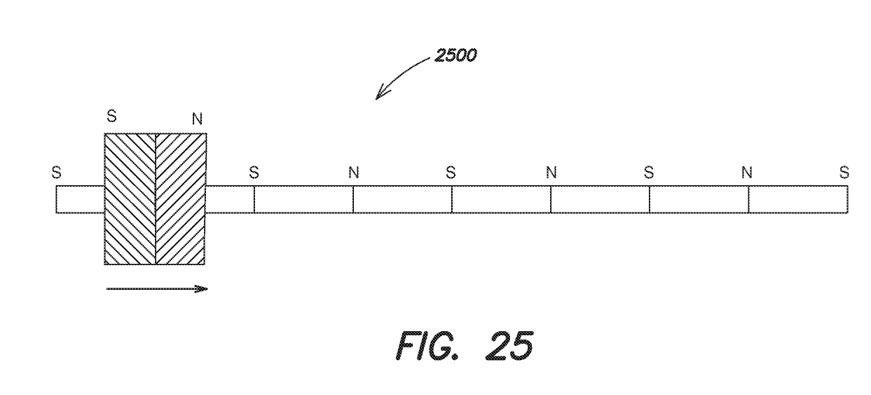

FIG. 25 is a view 2500 of another embodiment including a fixed magnetic car sliding on a magnetic rail that contains successive electromagnets configured to drive the magnetic car over the rail by changing the polarity of the electromagnets on the rail. For example, by creating attractive force local to the car (e.g., opposing magnetic pole in front of the car and repelling force (similar magnetic poles)) behind the car, the net effect is a forward movement of the car. In some embodiments, the polarity of the magnets can be manipulated by a control unit to increase the frequency of the magnetic polarity changes and increase speed.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A lift assist system, the lift assist system comprising:
a magnetic car coupled to a magnetic rail;
the magnetic rail, wherein the magnetic rail defines a cyclic track and includes:
a plurality of magnetic portions;
at least one curved portion of the rail;
a control unit configured to manipulate a magnetic field associated with at least the magnetic car or at least the magnetic rail;
wherein the magnetic car is driven along the magnetic rail responsive to the manipulation of the magnetic field by the control unit; and
wherein the at least one curved portion is constructed of an arc, such that in response to the magnetic car travelling along the arc, a lifting force is generated by the lift assist system.

2. The lift assist system according to claim 1, wherein the magnetic rail includes a plurality of curved portions each having a respective arc such that in response to the magnetic car travelling along the respective arc, a lifting force is generated by the lift assist system.

3. The lift assist system according to claim 2, wherein the system further comprises a plurality of magnetic cars, wherein operation of the plurality of magnetic cars is configured to create the lifting force generated by the lift assist system.

4. The lift assist system according to claim 1, wherein the control unit is further configured to sequentially manipulate a magnetic field produced by the plurality of magnetic portions of the rail.

5. The lift assist system according to claim 4, wherein the control unit is further configured to synchronize the movements of a plurality of magnetic cars along the plurality of curved portions of the magnetic rail.

6. The lift assist system according to claim 5, wherein synchronizing the movements includes synchronizing a first magnetic car and a second magnetic car such that as the first magnetic car travels along a first section of a first curved portion the second car travels along a second section of a second curved portion and the angular momentum of the first and second car combine to generate an upwardly directed force.

7. The lift assist system according to claim 6, wherein the control unit is further configured to:
pair at least two magnetic cars; and
control operations of at least a plurality of the at least two paired magnetic cars.

8. The lift assist system according to claim 7, wherein the control unit is further configured to maintain a spacing and speed for the at least two paired magnetic cars such that the angular momentum of the at least two paired magnetic cars combine to generate a force directed substantially upward.

9. The lift assist system according to claim 7, wherein the control unit is further configured to determine a spacing required between a first and second magnetic car such that the average force generated from their respective angular momentum is directed substantially upward and minimizes any other directional force.

10. The lift assist system according to claim 9, wherein the control unit is further configured to determine an average upward force generated by a plurality of pairs of magnetic cars and manipulate a spacing and speed of the magnetic cars to minimize any forces generated that are not upwardly directed.

11. A method for generating a lifting force, the method comprising:
moveably mating a plurality of magnetic cars to a magnetic rail that defines a cyclic track and includes at least a plurality of magnetic portions and a plurality of curved portions;
varying, by a control unit, a polarity of selective ones of the plurality of magnetic portions of the magnetic rail to induce motion by a first one of the plurality of magnetic car along the cyclic track;
varying, the control unit, a polarity of selective other ones of the plurality of magnetic portions of the magnetic rail to induce motion by a second one of the plurality of magnetic cars along the cyclic track;
sequencing, by the control unit, both acts of varying to maintain a spacing between the first and second magnetic cars, wherein the spacing is calculated to maximize a lifting force resulting from the angular momentum of the first and second magnetic cars.

12. The method according to claim 11, wherein sequencing includes manipulating a magnetic field produced by the plurality of magnetic portions of the rail.

13. The method according to claim 11, wherein sequencing includes synchronizing movement of each one of a plurality of magnetic cars along the plurality of curved portions of the magnetic rail.

14. The method according to claim 11, wherein the method further comprises:
pairing at least two magnetic cars; and
controlling based on pairs of magnetic cars the operation the plurality of magnetic cars.

15. The method according to claim 14, further comprising maintaining a spacing and a speed for at least two paired magnetic cars such that the angular momentum of the at least two paired magnetic cars combine to generate a force directed substantially upward.

16. The method according to claim 14, further comprising determining a spacing required between a first and second magnetic car such that the average force generated from their respective angular momentum is directed substantially upward.

17. The method according to claim 16, wherein the act of determining the spacing required includes minimizing an average of laterally directed forces.

18. The method according to claim 17, further comprising determining an average upward force generated by the plurality magnetic cars, and adjusting a respective spacing and a respective speed of one or more of the magnetic cars to minimize any laterally directed forces.
